(19) United States
(12) Patent Application Publication
(10) Pub. No.: US 2007/0261939 A1
(43) Pub. Date: Nov. 15, 2007

(54) Bulk supply hopper

(75) Inventor: Douglas M. Charpentier, Bristol, CT (US)

Correspondence Address: MCCORMICK, PAULDING & HUBER LLP, CITY PLACE II, 185 ASYLUM STREET, HARTFORD, CT, 06103, US

(73) Assignee: Arthur G. Russell Co., Inc., Bristol, CT (US)

(21) Appl. No.: 11/412,888

(22) Filed: Apr. 27, 2006

(51) Int. Cl. B65G 47/04

(52) U.S. Cl. 198/540

(57) ABSTRACT

A bulk supply hopper includes a hopper body for holding a plurality of bulk material items and defining a bulk supply hopper opening, a bulk supply hopper impelling means for impelling the bulk material items toward the bulk supply hopper opening, a bulk material separation means, arranged in the bulk supply hopper opening, for separating the bulk material items, and a control door disposed proximate to the bulk supply hopper opening. The bulk supply hopper, equipped with a control door, prevents dumped bulk material items from exiting the bulk supply hopper. The bulk supply hopper, using a conveyor belt as the bulk supply hopper impelling means, significantly reduces radiated noise. Additionally, the bulk supply hopper including opposed, substantially upright side walls, enhances the effectiveness of the conveyor belt.

### FIELD OF THE INVENTION

The present invention relates generally to feeder systems and, more particularly, to bulk supply hoppers for supplying bulk materials within a feeder system.

### BACKGROUND OF THE INVENTION

Feeder systems are widely used in numerous manufacturing, assembly, and supply processes to automatically separate bulk material items. The feeder systems feed the bulk materials for use in one or more process steps with appropriate spacing and/or orientation.

Typically, such feeder systems include a feeder and a bulk supply hopper. The bulk supply hopper initially separates the bulk material items and outputs a controlled supply of the bulk material items to the feeder through a bulk supply hopper opening. The feeder establishes the desired spacing and/or orientation of the bulk material items and supplies the bulk material items for subsequent processing steps.

Commonly, the bulk supply hopper employs a plurality of supply wheels in the bulk supply hopper opening to help separate the bulk material items, and a bulk supply hopper impelling means for impelling the bulk material in the hopper toward the supply wheels. When the bulk supply hopper impelling means is a vibratory impelling means, such as one or more linear vibrators, the vibratory motion also helps to separate the bulk material items. However, the vibratory impelling means generates excessive levels of noise. Conveyor belts, which are significantly quieter, are not used for the bulk supply hopper impelling means because the conveyor belts tend to dump bulk materials together.

Even bulk supply hoppers with vibratory impelling means periodically output dumped bulk material items to the feeder. When dumped bulk material items are supplied to the feeder during operation of the feeder system, feeder back-ups frequently occur. A back-up detection sensor is often provided in the feeder to stop the supply wheels of the bulk supply hopper in the event of a feeder back-up, to allow the feeder back-up time to clear.

To minimize the passage of dumped bulk material items from the bulk supply hopper to the feeder, one or more sensor wires are often provided in the bulk supply hopper opening, above the supply wheels. A dump of bulk material items passing over the supply wheels will outwardly displace the sensor wires. Outward displacement of the sensor wires will then result in stopping the bulk supply hopper impelling means, thus allowing the supply wheels to break up existing dumps without additional bulk material items being impelled toward the bulk supply hopper opening. However, nothing impedes the clumped bulk material items that initially displaced the wire sensors from passing over the supply wheels and entering the feeder, where the presence of the clumped bulk material items lead to feeder back-ups and further delays.

From the foregoing, it can be seen that there exists a need for a bulk supply hopper that does not pass dumped bulk materials to a feeder. It can also be seen that there is a need for a bulk supply hopper capable of satisfactorily separating bulk materials, while generating substantially less noise during operation.

### SUMMARY OF THE INVENTION

According to an embodiment of the present invention, a bulk supply hopper includes a hopper body for holding a plurality of bulk material items and defining a bulk supply hopper opening, a bulk supply hopper impelling means for impelling the bulk material items toward the bulk supply hopper opening, a bulk material separation means, arranged in the bulk supply hopper opening, for separating the bulk material items, and a control door disposed proximate to the bulk supply hopper opening.

It will be appreciated from the detailed description and drawings that the bulk supply hopper of the present invention, equipped with a control door, prevents clumped bulk material items from exiting the bulk supply hopper. It will further be appreciated that the bulk supply hopper of the present invention, using a conveyor belt as the bulk supply hopper impelling means, significantly reduces radiated noise. Additionally, the bulk supply hopper of the present invention includes opposed, substantially upright side walls, thereby enhancing the effectiveness of the conveyor belt.

These and other features, objects, and advantages of the present invention will be better understood in view of the drawings and detailed description.

### BRIEF DESCRIPTION OF THE DRAWINGS

FIG. 1 is a partial perspective view of a feeder system, including a bulk supply hopper, according to an embodiment of the present invention;

FIG. 2 is a perspective view of the bulk supply hopper of FIG. 1;

FIG. 3 is a side view of the bulk supply hopper of FIG. 2;

FIG. 4 is a rear view of the bulk supply hopper of FIG. 2;

FIG. 5 is a front view of the bulk supply hopper of FIG. 2;

FIG. 6 is an enlarged partial cross-sectional side view of the bulk supply hopper taken along line 6-6 of FIG. 5; and

FIG. 7 is an enlarged partial perspective view of the bulk supply hopper of FIG. 2.

### DETAILED DESCRIPTION OF A PREFERRED EMBODIMENT

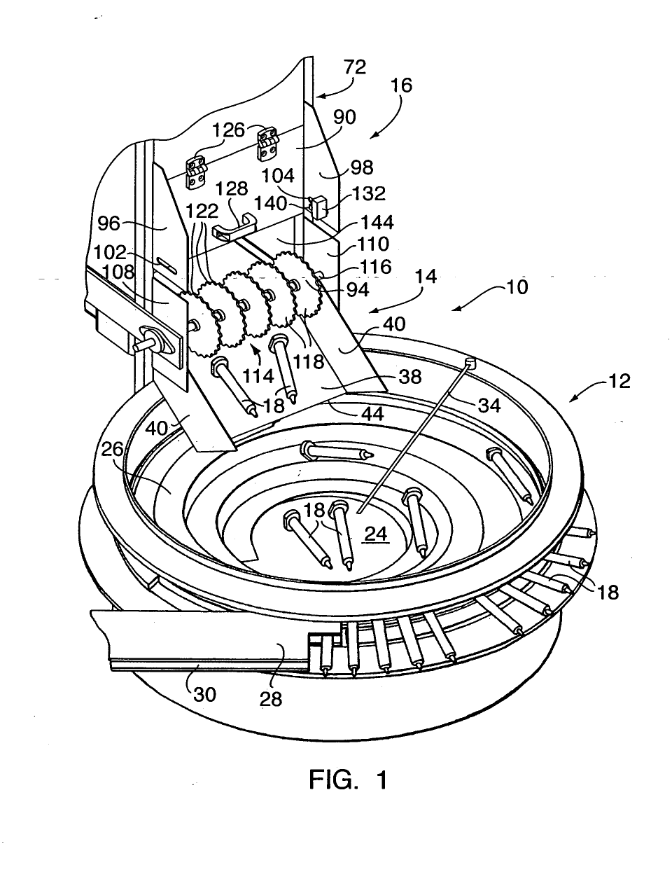

Referring to FIG. 1, a feeder system 10 includes a feeder 12, a chute 14, and a bulk supply hopper 16. Bulk material items 18 outputted by the bulk supply hopper 16 are guided to the feeder 12 from the bulk supply hopper 16 via the chute 14.

The feeder 12 is formed with a feeder bowl 24, a spiral ramp 26, and an exit path 28. The spiral ramp 26 connects the feeder bowl 24 with the exit path 28. The exit path 28 includes an orientation groove 30. The feeder 12 vibrates to supply the motive force necessary to impel bulk material items 18 in the feeder bowl 24 up the spiral ramp 26 and to the exit path 28. Vibration is imparted to the feeder by a feeder impelling means, such as at least one linear vibrator. A feeder back-up detection sensor 34, such as a rigid, rotatable wire, is positioned over the feeder bowl 24.

The chute 14 is formed with a sloped base 38 having retention walls 40 extending upward from the edges of the sloped base. The base 38 and retention walls 40 cooperate to guide bulk materials items 18 outputted by the bulk supply hopper 16. After sliding off the sloped base 38, the bulk material items 18 fall into the feeder bowl 24. An upper end 42 of the sloped base 38 is attached to the bulk supply hopper 16. A lower end 44 of the sloped base 38 terminates over the feeder bowl 24. The chute 14 is positioned sufficiently far above the feeder 12 to ensure that the bulk material items 18 moving up the spiral ramp 26 do not contact the chute 14.

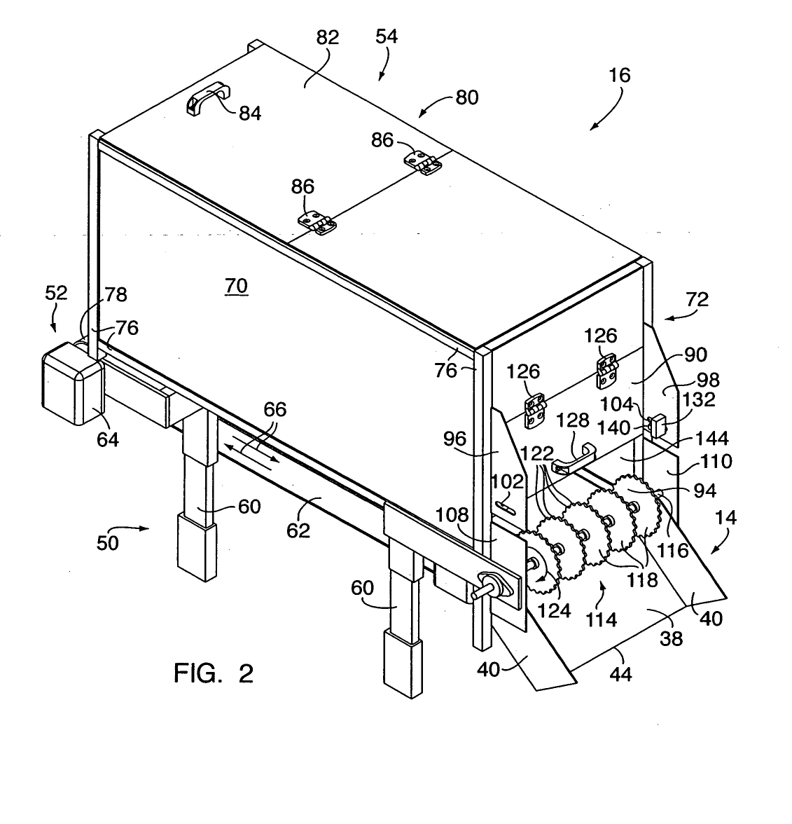

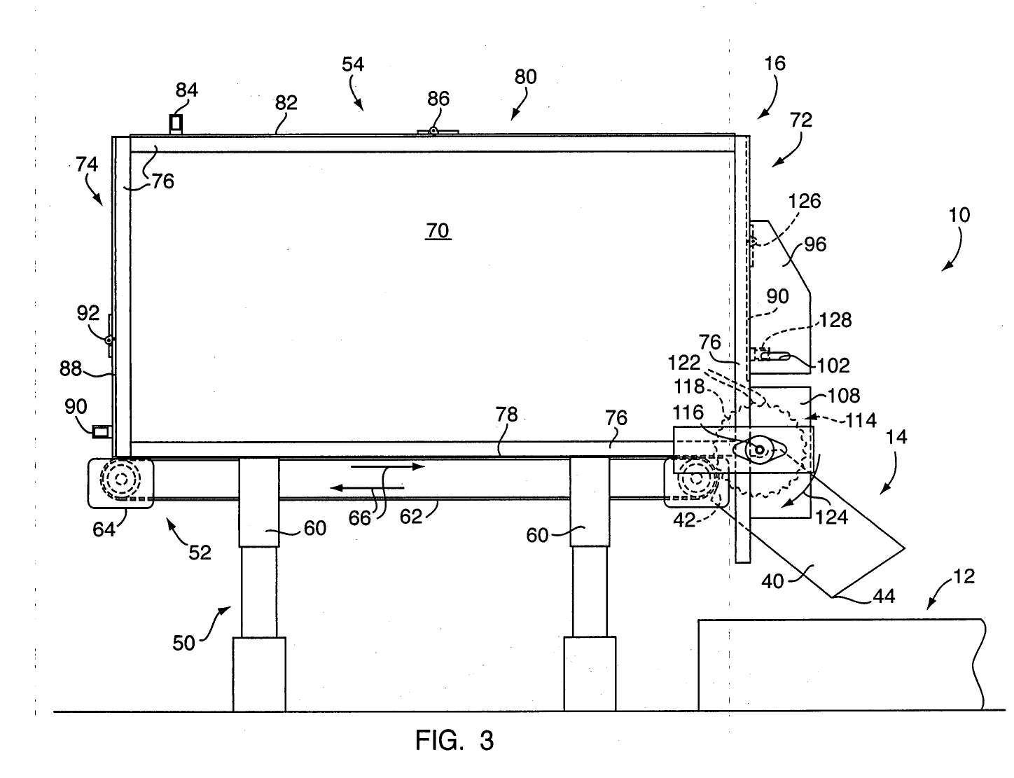

Referring to FIGS. 2 and 3, the bulk supply hopper 16 includes a base 50, a bulk supply hopper impelling means 52, and a hopper body 54. The base 50 is formed from a plurality of legs 60. The legs 60 are dimensioned to position the chute 14 sufficiently far above the feeder 12, as best seen in FIG. 3. The bulk supply hopper impelling means 52 includes a conveyor belt 62 driven by a conveyor belt motor 64. The conveyor belt 62 is driven by the conveyor belt motor 64 in the direction shown by the arrows 66. The hopper body 54 is defined by a plurality of walls 70-74 connected to a frame 76. The plurality of walls 70-74 includes two opposing side walls 70, a front wall 72, and a back wall 74 that opposes the front wall 72. The hopper body 54 is further defined by a conveyor belt upper surface 78, and cover 80 opposing the conveyor belt upper surface 78. The plurality of walls 70-74 are substantially upright, and extend upward substantially perpendicular to the conveyor belt upper surface 78. The hopper body 54 is dimensioned to accommodate the type and quantity of bulk material items 18 to be outputted to the feeder 12.

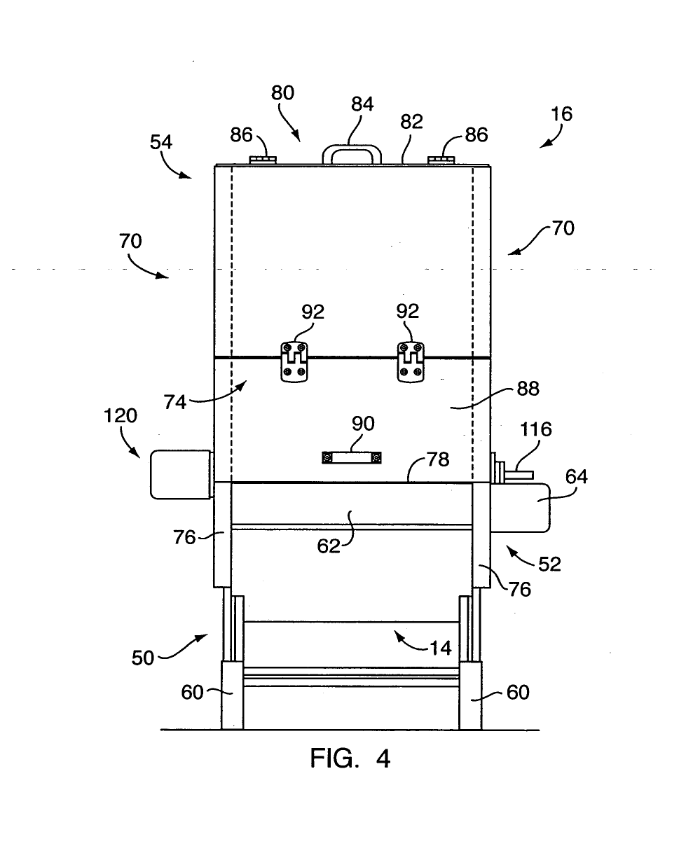

The cover 80 includes a hinged cover portion 82 to facilitate loading, unloading, and inspection of the hopper body 54. A handle 84 and one or more hinges 86 are connected to the hinged cover portion 82 to facilitate opening of the hinged cover portion 82. When dosed, the hinged cover portion 82 rests on the frame 76. Referring to FIG. 4, the back wall 74 includes a hinged back wall portion 88, for purposes similar to the hinged cover portion 82. A handle 90 and one or more hinges 92 are connected to the hinged back wall portion 88 to facilitate opening. The hinged back wall portion 88 rests on the frame 76 when dosed.

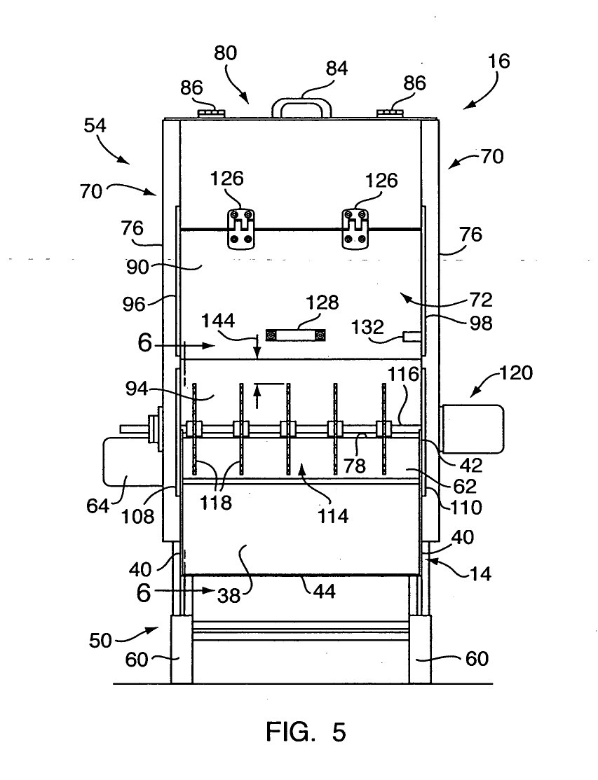

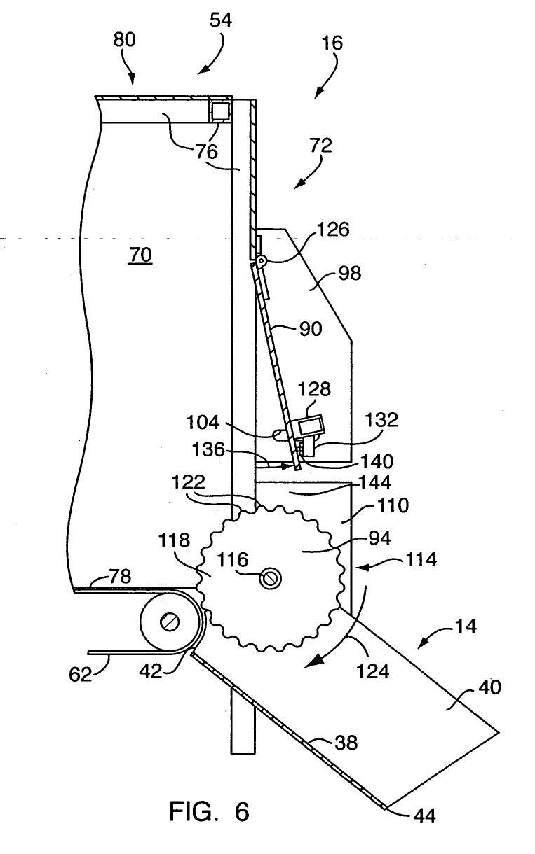

Referring to FIGS. 5 and 6, the front wall 72 of the bulk supply hopper 16 includes a control door 90 and partially defines a bulk supply hopper opening 94. The bulk supply hopper opening 94 is further defined by the frame 76 and the conveyor belt upper portion 78. Opposing first and second upper brackets 96, 98 extend from the front wall 72 and flank the control door 90. First and second upper slots 102, 104, best seen in FIG. 2, are formed in the first and second upper brackets 96, 98, respectively. Opposing first and second lower brackets 108, 110 extend from the front wall 72 and flank the bulk supply hopper opening 94.

A bulk material separation means 114 is provided in the bulk supply hopper opening 94. The bulk material separation means includes an axle 116, a plurality of supply wheels 118, and a supply wheel driving means 120. The axle 116 is rotatably mounted to the first and second lower brackets 108, 110. The axle 116 extends between the first and second lower brackets 108, 110 and across the bulk supply hopper opening 94. The supply wheels 118 are arranged across the bulk supply hopper opening 94, each of the supply wheels being mounted to the axle 116. The supply wheels 118 are spaced substantially evenly, and are substantially parallel to each other and to the first and second lower brackets 108, 110. Each of the supply wheels 118 is formed with a plurality of teeth 122 to better engage and separate the bulk material items 18.

The axle 116 is mounted slightly above the conveyor belt upper portion 78 and forward of the front wall 72, allowing each supply wheel 118 to partially protrude into the hopper body 54. The supply wheels 118 are fixed to the axle 116 so as to rotate in unison when the axle 116 is rotated in the direction indicated by the arc 124. The axle 116 and supply wheels 118 are rotated by the supply wheel driving means 120, such as a supply wheel motor. The supply wheel driving means 120 communicates with the feeder back-up detection sensor 34, seen in FIG. 1.

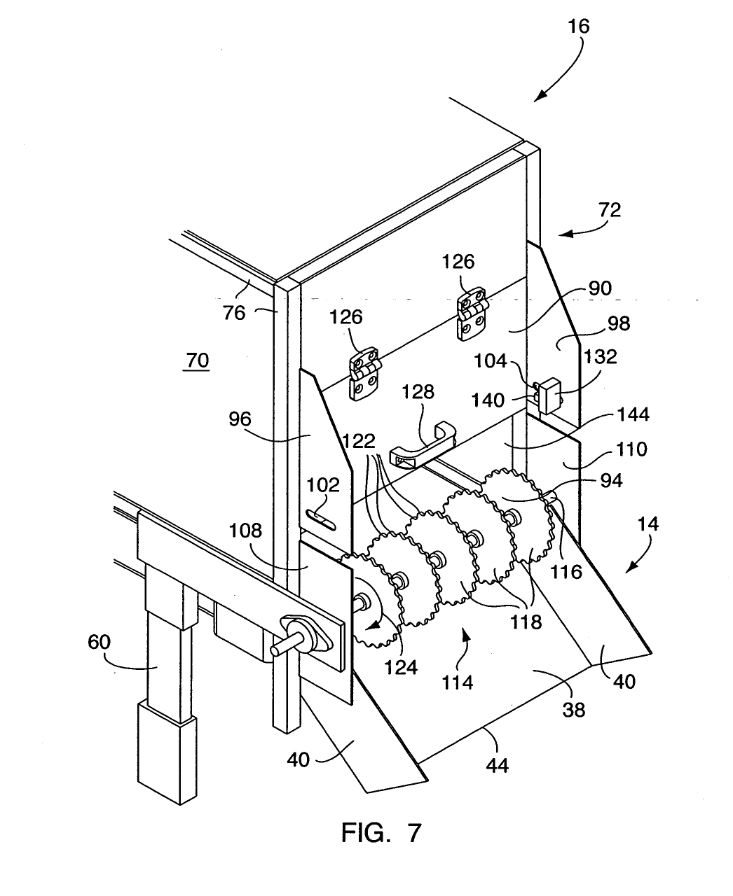

The control door 90 is rotatable outwards by means of one or more hinges 126. Using an attached handle 128, the control door 90 is also manually rotatable. Referring to FIG. 7, a tab 132 mounted in the second upper slot 104 extends in front of the control door 90. The tab establishes an outward rotation limit 136, best seen in FIG. 6, for the control door 90. The outward rotation limit 136 is varied by moving the tab 132 in the second upper slot 104.

A control door position sensor 140 is mounted on the tab 132. The control door position sensor 140 detects when the control door 90 reaches the outward rotation limit 136. The control door position sensor 140 communicates with the bulk supply hopper impelling means 52.

An upper opening portion 144 between the control door 90 and the supply wheels 118, best seen in FIG. 5, is preferably dimensioned such that a clump of bulk material items 18 will not fit between the control door 90 and the supply wheels 118. The outward rotation limit 136, best seen in FIG. 6, is preferably selected such that the bulk material items 18 will still not be able to exit the upper opening portion 144 between the supply wheels 118 and the outwardly rotated control door 90.

In operation of the feeder system 10, the bulk supply hopper 16 is initially loaded with bulk material items 18 through the hinged cover portion 82. The conveyor belt motor 64 drives the conveyor belt 62. The bulk material items 18 in the hopper body 54 are impelled forward toward the supply wheels 118 by the motion of the conveyor belt 62. Separated bulk material items 18 that are impelled past the supply wheels 118 pass through the bulk supply hopper opening 94. These separated bulk material items 18 slide down the chute 14 and fall into the feeder bowl 24. Clumped bulk material items 18 cannot fit past the supply wheels 118 and are engaged and separated by the motion of the supply wheels 118.

If the clumped bulk material items 18 are impelled over the supply wheels 118 without being separated, the dumped bulk material items 18 cannot fit through the upper opening portion 144. If the clumped bulk material items 18 do not fall back into the hopper body 54 and continue to be impelled forward, the dumped bulk material items 18 will push against the control door 90. As the dumped bulk material items 18 push against the control door 90, the control door 90 will rotate outward until the dumped bulk material items 18 fall back into the hopper body 54 or until the control door 90 reaches the outward rotation limit 136.

If the control door 90 reaches the outward rotation limit 136, the control door position sensor 140 will communicate with conveyor belt motor 64 such that the conveyor belt motor 64 is stopped. With the conveyor belt motor 64 stopped, motion of the conveyor belt 62 will also cease. Bulk material items 18 will no longer be continuously impelled toward the supply wheels 118 by the conveyor belt 62. Free from the pressure of backed-up bulk material items 18, the supply wheels 118 will separate the dumped bulk material items 18. The now-separated bulk material items 18 will pass out the bulk supply hopper opening 94 to the chute 14. No longer forced outward by the dumped bulk material items 18, the control door 90 will rotate inwards, causing the control door position sensor 140 to detect that the control door 90 is no longer at the outward rotation limit 136. The control door position sensor 140 will then communicate with the conveyor belt motor 64 such that the conveyor belt motor 64 is re-started. With the conveyor belt 62 again in motion, additional bulk material items 18 will be impelled forward to the supply wheels 118. These bulk supply hopper 16 operations will recur until the bulk supply hopper 16 has been emptied or stopped.

The separated bulk material items 18 that are outputted to the feeder bowl 24 are impelled up the spiral ramp 26 by the vibratory motion of the feeder 12. Properly-oriented and/or spaced bulk material items 18 leave feeder 12 via the exit path 28. Improperly oriented bulk material items 18 ultimately fall back into the feeder bowl 24, and are impelled again up the spiral ramp 26.

Due to various factors, the rate at which separated bulk items 18 are outputted by the bulk supply hopper 16 can exceed the rate at which properly-oriented bulk material items 18 are leaving the feeder 12. Consequently, the level of bulk material items 18 in the feeder 12 will rise sufficiently to cause the feeder back-up detection sensor 34 to detect the high-level condition. The feeder back-up sensor 34 communicates with the supply wheel driving means 120 such that the supply wheel driving means 120 is stopped, stopping the rotation of the supply wheels 118 and effectively halting the output of bulk material items 18 to the feeder 12. If the supply wheels 118 are stopped for an extended time, it is likely that a back-up will also develop within the bulk supply hopper 16, resulting in control door 90 rotation to the outward rotation limit 136 and subsequent stoppage of the conveyor belt 62.

Without the additional bulk material items 18 being supplied by the bulk supply hopper 16, the feeder 12 will eventually clear the feeder 12 back-up. The feeder back-up detection sensor 34 will then communicate with the supply wheel driving means 120 such that rotation of the supply wheels 118 resumes and additional separated bulk material items 18 are outputted to the feeder 12. As with the operations of the bulk supply hopper 16, these feeder 12 operations will recur until the feeder 12 is stopped or until the bulk supply hopper 16 and feeder 12 are empty.

From the foregoing it can be seen that a bulk supply hopper 16 with a control door 90 will greatly enhance the operability and efficiency of the feeder system 10. The present invention substantially prevents dumped bulk material items 18 from exiting the bulk supply hopper 16 without first being separated, resulting in less back-ups in the feeder 12 and generally streamlining the passage of bulk material items 18 through the feeder system 10.

The improved bulk supply hopper 16 with a control door 90 allows conveyor belts 62, which otherwise tend to dump bulk material items 18 together, to be advantageously employed as the bulk supply hopper impelling means 52. The use of a conveyor belt 62 equipped bulk supply hopper 16, as opposed to a vibratory bulk supply hopper, dramatically decreases the radiated noise produced by the feeder system 10, and works well in connection with substantially upright side walls 70.

It will be dear to those skilled in the art that various modifications and variations are possible without departing from the scope of the present invention. For example, a vibratory bulk supply hopper with a feeder impelling means other than linear vibrator can be used. Other non-vibratory, feeders can be employed. Various feeder back-up detection sensors 34 can be used, other than the rigid, rotatable wire shown. Various designs of the chute 14 can be employed within the scope of the present invention. For example, retention walls 40 can be omitted. Additionally, the chute 14 can be entirely omitted. The base 50 need not be integral with or included in the bulk supply hopper 16. Bases having designs other than the base 50 can also be suitable for supporting the hopper body 54.

The present invention is not limited to a particular type of bulk material items 18. As will be appreciated by those skilled in the art, modifications within the scope of the present invention can enable use with substantially all bulk material items.

Additionally, the hopper body 54 need not include a cover 80, and can also be formed with other geometries, including outwardly sloping sides, front, and/or back. The hopper body 54 is preferably sized based on the type and quantity of bulk material items 18 to be supplied. Volumes of 2 to 40 cubic feet are typical, though other sizes are, of course, possible.

Although the back wall 74 and cover 80 of the bulk supply hopper 16 in the drawings include hinged portions 82, 88, a hinged portion could also be included on one or more of the sides 70, or excluded from any or all of the walls 70-74 and/or cover 80. Further, it is not necessary that such portions be hinged, but instead could lift completely off or be attached in other ways, as known in the art. The bulk supply hopper 16 can be loaded using the hinged cover portion 82, through another wall portion, or using other known loading means.

A bulk supply hopper 16 equipped with a control door 90 can also employ other bulk supply hopper impelling means 52. A vibratory supply hopper, can, for example, be used to provide the motive force to bulk material 18 in the hopper body 54.

Although the use of supply wheels 118 with a plurality of teeth 122 in the bulk supply hopper opening 94 is preferred, other bulk material separation means 114 can also be employed. For instance, supply wheels without teeth can also be employed, or a non-rotational bulk material separation means. Additionally, the number size and pacing of the supply wheels 118 is preferably determined as a function of the size, type, and/or geometry of the bulk material items 18 to be supplied. For example, a number and spacing of supply wheels 118 is preferably chosen such that clumped bulk material items 18 are not able to pass between adjacent supply wheels 118.

Preferably, the conveyor belt 62 and supply wheels 118 are independently driven by separate drive means 64, 120, although other driving means for the conveyor belt and/or supply wheels are within the scope of the invention. A common driving means could be employed and separately engaged to the supply wheels 118 and conveyor belt 62 via a clutch, or a dutch and reduction gearing (if, for instance, different rotational speeds are desired while still using the common driving means).

The conveyor belt upper surface 78 preferably extends close enough to prevent bulk material items 18 from exiting between the conveyor belt 62 and the supply wheels 118, but is far enough to prevent interference between the conveyor belt 62 and the supply wheels 118. A segmented conveyor belt can be employed to allow intermeshing of the supply wheels 118 and the segmented conveyor belt.

Also, the control door 90 is not limited to any particular geometry. For instance, the control door need not be completely solid or rectangular, but is preferably dimensioned to partially cover a wall, or similar surface, of the bulk supply hopper 16 proximate the bulk supply hopper opening 94, such that clumped bulk material items 18 loaded in the bulk supply hopper 16 cannot pass through or around the control door 90. For example, a screen mesh control door can be employed.

Though the control door 90 is preferably rotatably mounted above the supply wheels 118, the control door 90 can be mounted in other fashions so as to be outwardly displaced by the force of bulk material items 18 in the bulk supply hopper 16. For instance, the control door 90 can be mounted on slides and would translate, rather than rotate, outward and could be provided with an outward translation limit. Accordingly, references to outward motion limits herein do not necessarily refer to a translation or rotational limit, unless specified.

Additionally, unless otherwise specified, the present invention is not limited to a control door 90 having an outward motion limit, such as outward rotation limit 136, of any particular magnitude. For example, a very small or indiscernible outward motion limit may be used. Preferably, the outward motion limit is established such that bulk material items 18 are still unable to pass out the bulk supply hopper opening 94 between the bulk material separation means 114 and the outwardly displaced control door 90.

The tab 132, or other physical position stop, need not be used to physically set the outward motion limit. For instance, the weight of the control door 90 may be sufficient for certain types of bulk material items to prevent an undesirable degree of outward motion, or the securing of the bulk supply hopper impelling means 52 may be sufficient to quickly relieve the pressure exerted by the dumped bulk material items 18 on the control door 90 to substantially preclude the possibility of the clumped bulk material items 18 exiting the bulk supply hopper 16.

The control door position sensor 140 is shown as a contact sensor although other sensor types can be advantageously employed within the scope of the invention. The sensor can be magnetic or can employ a linear variable differential transformer. An optical sensor can be employed. The sensor can sense only two control door positions, for example, open to the outward motion limit and not open to the outward motion limit, or can sense a range of control door positions. The communication between the control door position sensor and the driving means for the conveyor belt can take various forms known in the art. For instance, the door position sensor can directly interrupt or supply current to an electric motor, or can cause the electric motor to be started or secured via auxiliary contacts in a motor controller. Alternatively, the door position sensor output can be an input to a programmable logic controller (PLC) or other digital control means.

In a relatively simple arrangement, opening the control door 90 to its outward motion limit engages a contact sensor 140, resulting in an open circuit in the circuit supplying power to the conveyor belt electric motor 64, thereby securing the motor 64. Sufficient inward motion of the control door 90 disengages the contact sensor 140, closing the power supply circuit and restoring power to the conveyor belt motor 64. Adjustment to the motor on/off response is made by mechanically adjusting the door tab 132 and/or the contact sensor.

In a more complex arrangement, a control door position sensor is employed capable of detecting each degree, or smaller decrement, of control door position. The control door position is inputted to a programmable logic controller (PLC), which outputs a control signal to a controller for the electric motor. The PLC is programmed to slow and ultimately stop the electric motor based upon stored tables correlating degrees of door opening to motor speed. Motor response can be varied, for example, both by mechanically altering the door tab(s) and/or position sensor, and by changing the PLC programming. This variety of sensors and communications can also be advantageously employed for communications between the feeder back-up detection sensor and the supply wheel driving means.

It will be appreciated by those skilled in the art that the present invention is not limited to the preferred embodiment and the variations described, but that these and other variations and modifications can be made while remaining within the scope of the present invention.

What is claimed is:

1. A bulk supply hopper comprising:
a hopper body for holding a plurality of bulk material items and defining a bulk supply hopper opening;
a bulk supply hopper impelling means for impelling the bulk material items toward the bulk supply hopper opening;
a bulk material separation means, arranged in the bulk supply hopper opening, for separating the bulk material items; and
a control mechanism disposed proximate to the bulk supply hopper opening for preventing clumped bulk material items from exiting the bulk supply hopper.

2. The bulk supply hopper of claim 1, wherein the control mechanism is a control door.

3. The bulk supply hopper of claim 2, wherein the bulk supply hopper further comprises a control door position sensor for sensing a motion of the control door.

4. The bulk supply hopper of claim 1, wherein the bulk supply hopper further comprises a position sensor for sensing a motion of the control mechanism.

5. The bulk supply hopper of claim 4, wherein the bulk supply hopper impelling means is slowed based on the motion sensed by the position sensor.

6. The bulk supply hopper of claim 4, wherein the bulk supply hopper impelling means is stopped based on the motion sensed by the position sensor.

7. The bulk supply hopper of claim 4, wherein the bulk supply hopper impelling means is slowed or stopped based on the motion sensed by the position sensor.

8. The bulk supply hopper of claim 4, wherein the motion sensed by the position sensor includes an outward motion limit, and the bulk supply hopper impelling means is stopped at the outward motion limit.

9. The bulk supply hopper of claim 4, wherein the motion sensed by the position sensor includes a range of control mechanism positions up to the outward motion limit, and the bulk supply hopper impelling means is incrementally slowed over at least a portion of the range of control mechanism positions and stopped at the outward motion limit.

10. The bulk supply hopper of claim 1, wherein the bulk supply hopper impelling means includes a conveyor belt.

11. The bulk supply hopper of claim 1, wherein the hopper body is formed by a plurality of walls, the plurality of walls including at least two substantially upright side walls.

12. A bulk supply hopper comprising:
a hopper body for holding a plurality of bulk material items and defining a bulk supply hopper opening;
a bulk supply hopper impelling means for impelling the bulk material items toward the bulk supply hopper opening;
a bulk material separation means, arranged in the bulk supply hopper opening, for separating the bulk material items; and
a control door disposed proximate to the bulk supply hopper opening.

13. The bulk supply hopper of claim 12, wherein the bulk supply hopper further comprises a control door position sensor for sensing a motion of the control door.

14. The bulk supply hopper of claim 13, wherein the bulk supply hopper impelling means is slowed or stopped based on the motion sensed by the control door position sensor.

15. The bulk supply hopper of claim 14, wherein the motion sensed by the control door includes an outward motion limit, and the bulk supply hopper impelling means is stopped at the outward motion limit.

16. The bulk supply hopper of claim 15, wherein the motion sensed by the control door position sensor includes a range of control door positions up to the outward motion limit, and the bulk supply hopper impelling means is incrementally slowed over at least a portion of the range of control door positions and stopped at the outward motion limit.

17. The bulk supply hopper of claim 12, wherein the bulk supply hopper impelling means includes a conveyor belt.
